(19) United States
(12) Patent Application Publication
(10) Pub. No.: US 2025/0315610 A1
(43) Pub. Date: Oct. 9, 2025

(54) METHOD AND APPARATUS FOR FINE-GRAINED SELF-ENDORSEMENT IMPROVES FACTUALITY AND REASONING

(71) Applicant: TENCENT AMERICA LLC, Palo Alto, CA (US)

(72) Inventors: Linfeng SONG, Palo Alto, CA (US); Baolin PENG, Palo Alto, CA (US); Haitao MI, Palo Alto, CA (US)

(73) Assignee: TENCENT AMERICA LLC, Palo Alto, CA (US)

(21) Appl. No.: 18/629,243

(22) Filed: Apr. 8, 2024

(51) Int. Cl. G06F 40/20

(52) U.S. Cl. CPC G06F 40/20

(57) ABSTRACT

A method comprises generating, based on inputting an input query into a large language model (LLM), N sample responses, N being an integer greater than zero; determining, for each sample response, each fact statement included in a respective response; determining, for each determined fact statement, an endorsement score indicating an accuracy of the fact statement as a response to the input query; selecting each fact statement having an endorsement score greater than a threshold; and generating a final response to the input query based on each selected fact statement.

### FIELD

The disclosure generally relates to fine-grained self-endorsement for improving faculty and reasoning.

### BACKGROUND

Recent Large Language Models (LLMs) such as LLaMA and Mistral take billions of parameters and are trained on huge corpora of text documents with billions of tokens. As a result, they have demonstrated remarkable capabilities across various tasks such as longform generation, closed book QA and math reasoning. However, LLMs still fail frequently on these knowledge-intensive and reasoning tasks where obvious incorrect facts or reasoning steps are generated. To address this issue, previous works have explored multiple orthogonal directions, such as introducing external knowledge and tools, continual supervised fine-tuning and inference-time improvement to reduce hallucination and improve reasoning capability. Among these research directions, inference-time improvement has recently gained popularity. The motivation behind this direction may stem from various reasons including it can be used on black-box LLMs (e.g., no requirement on accessing the model weighs), and it can work together with supervised fine-tuning by producing high-quality training data (e.g., self-distillation).

Many prior approaches of inference-time improvement can be grouped into two main directions. The ensemble methods like self-consistency and universal self-consistency build upon traditional ensemble learning by picking the optimal prediction from multiple candidates sampled from the target LLM. Conversely, in the other directions, self-refinement methods such as chain-of-verification and self-reflection leverage the target LLM to refine its own predictions from varied perspectives. Comparatively, the ensemble methods can eliminate occasional hallucinations by looking into multiple peering samples. But, they may fail on longform generation tasks because the sampled candidates disagree with each other on too many places, making it difficult to pick the best prediction. More importantly, these methods cannot combine the merits from the peering samples. On the other hand, the self-refinement methods perform fine-grained refinement. But they rely on the assumption that the target LLM is strong enough to provide helpful critique for refinement, and thus, most experiments on them are conducted on state-of-the-art close-source LLMs (e.g., GPT4).

### SUMMARY

According to one or more embodiments, a method performed by at least one processor comprising: generating, based on inputting an input query into a large language model (LLM), N sample responses, N being an integer greater than zero; determining, for each sample response, each fact statement included in a respective response; determining, for each determined fact statement, an endorsement score indicating an accuracy of the fact statement as a response to the input query; selecting each fact statement having an endorsement score greater than a threshold; and generating a final response to the input query based on each selected fact statement.

According to one or more embodiments, an apparatus comprises: at least one memory configured to store program code; and at least one processor configured to read the program code and operate as instructed by the program code, the program code including: first generating code configured to cause the at least one processor to generate, based on inputting an input query into a large language model (LLM), N sample responses, N being an integer greater than zero, first determining code configured to cause the at least one processor to determine, for each sample response, each fact statement included in a respective response, second determining code configured to cause the at least one processor to determine, for each determined fact statement, an endorsement score indicating an accuracy of the fact statement as a response to the input query, selecting code configured to cause the at least one processor to select each fact statement having an endorsement score greater than a threshold, and second generating code configured to cause the at least one processor to generate a final response to the input query based on each selected fact statement.

According to one or more embodiments, a non-transitory computer readable medium having instructions stored therein, which when executed by a processor cause the processor to execute a method comprising: generating, based on inputting an input query into a large language model (LLM), N sample responses, N being an integer greater than zero; determining, for each sample response, each fact statement included in a respective response; determining, for each determined fact statement, an endorsement score indicating an accuracy of the fact statement as a response to the input query; selecting each fact statement having an endorsement score greater than a threshold; and generating a final response to the input query based on each selected fact statement.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of a self-endorsement framework, according to embodiments.

FIG. 4 is a flowchart of a self-endorsement process, according to embodiments.

FIG. 5 is a table of test results on biographies, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

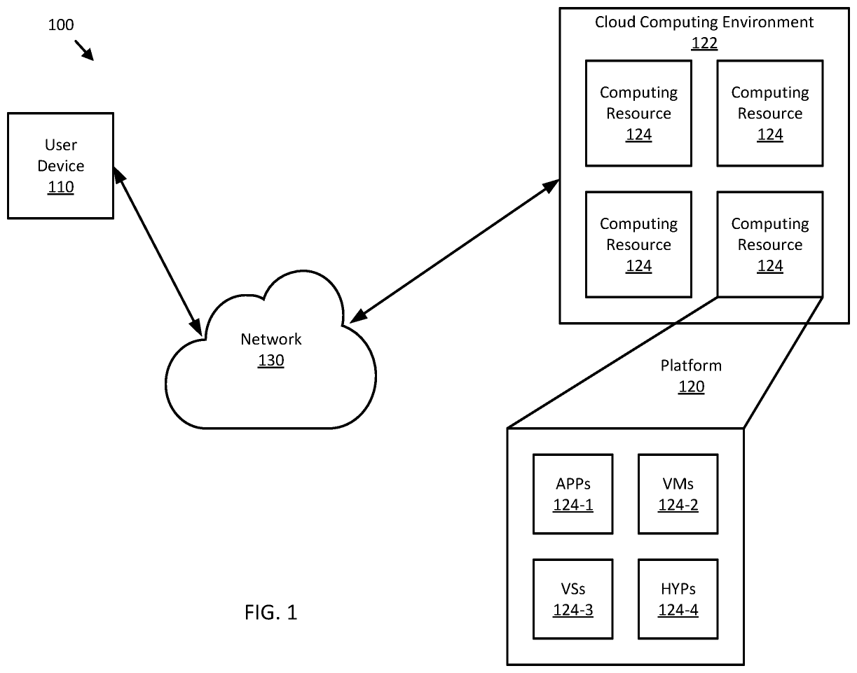

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

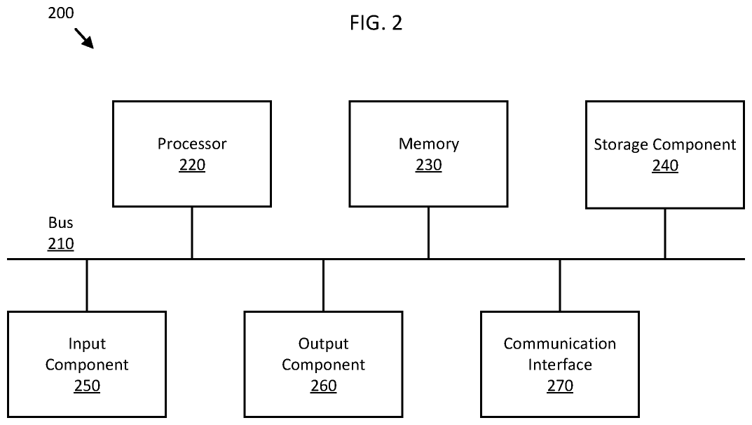

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Embodiments of the present disclosure are directed to improving large language model (LLM) generations at inference time by mitigating fact-conflicting hallucinations. A hallucination may be an incorrect or non-sensical response from the LLM to an input query. The embodiments of the present disclosure provide a self-endorsement framework that leverages the fine-grained fact-level comparisons across multiple sampled responses. Compared with prior ensemble methods (e.g., self-consistency) that perform response-level selection, the embodiments of the present disclosure better alleviate hallucinations, especially for longform generation tasks. The embodiments of the present disclosure broadly benefit smaller and open-source LLMs as it mainly conducts content-based comparisons. Experiments on Biographies show that the embodiments of the present disclosure effectively improve the factuality of generations with simple and intuitive prompts across different scales of LLMs. Furthermore, comprehensive analyses on TriviaQA and GSM8K demonstrate the potential of self-endorsement for broader application.

The embodiments of the present disclosure follow the line of inference-time improvement to study how and when fine-grained cross-response validation (e.g., endorsement) reduces hallucinations and improves reasoning quality. Particularly, the embodiments of the present disclosure propose a framework to improve LLM predictions by leveraging fine-grained cross-response endorsements.

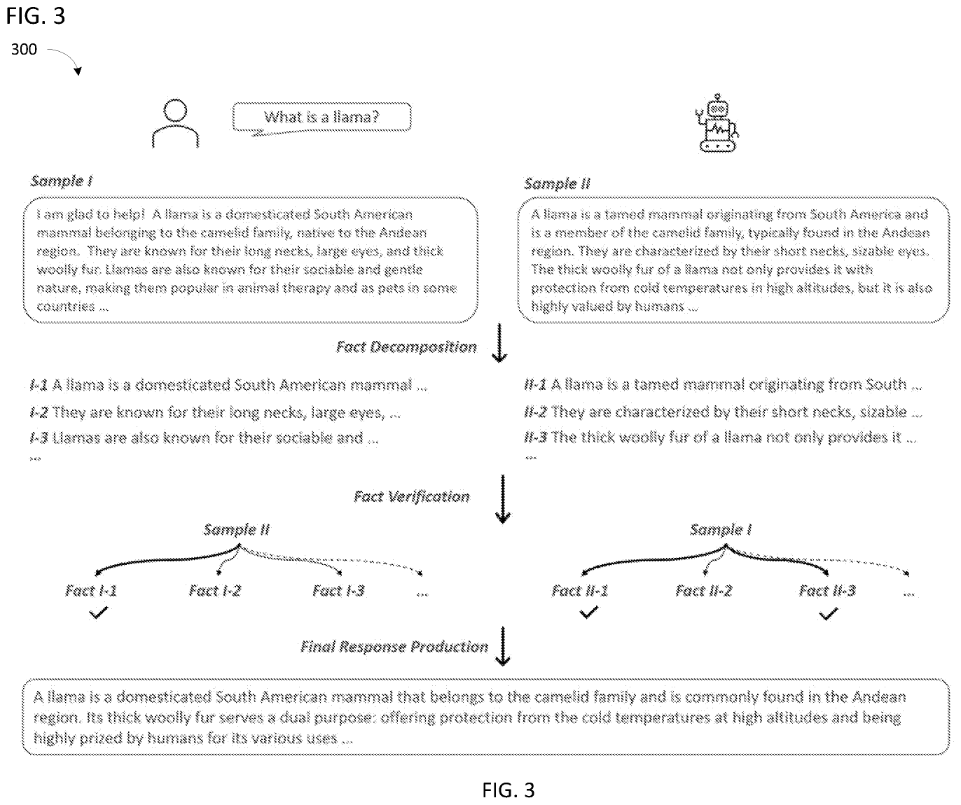

FIG. 3 illustrates an example frame work for a self-endorsement framework.

The process may start by generating multiple samples from the target LLM. The samples may be generated by inputting an input query (e.g., “What is a llama”?) into the LLM. Next, fact decomposition may be performed to extract facts from each sample and prompt the LLM to verify the endorsement of each fact by cross-referencing with the other samples. Next fact verification may be performed in which an endorsement score is assigned to each fact based on its level of approval. Finally, to produce the final response, the sample with the most reliable facts are selected or a new response is regenerated by incorporating the facts with high endorsement scores as supplementary inputs to the LLM.

Without complex instructions, the LLM is only required to conduct two tasks: 1) check whether a fact is consistent with the knowledge in another response at a time; 2) generate a new response given additional high-quality facts as inputs. Both tasks are not processing intensive, and thus, as shown in the experiments discussed later, the embodiments of the present disclosure enhance the operation of various open-source LLMs of different capacities.

As shown in FIG. 3, the self-endorsement framework interacts with an LLM by taking the following steps given a user query X.

First, candidate sampling is performed where the LLM is requested to sample N candidate responses Y₁, Y₂, . . . , Y_{N} (e.g., query X is inputted into the LLM N times to generate N sample responses).

Second, fact decomposition is performed where each candidate Yᵢ is broken

$${f}_{1}^{i} , {f}_{2}^{i} , … , {f}_{{N}_{{Y}_{i}}}^{i} ,$$

down into facts where Ny, is the number of facts in Yᵢ.

Third, fact verification is performed where each fact

$${f}_{j}^{i}$$

is verified via calculating its endorsement scores against other candidates {Yₖ|k≠i}. Context pruning may be performed by eliminating unrelated content in candidates for verification.

Fourth, final response production is performed where a final response is produced via selection or regeneration. Specifically, either the response is selected with facts having the highest endorsement scores as the final response or the LLM is requested to regenerate a new response Y given the set of selected facts Z from different candidates.

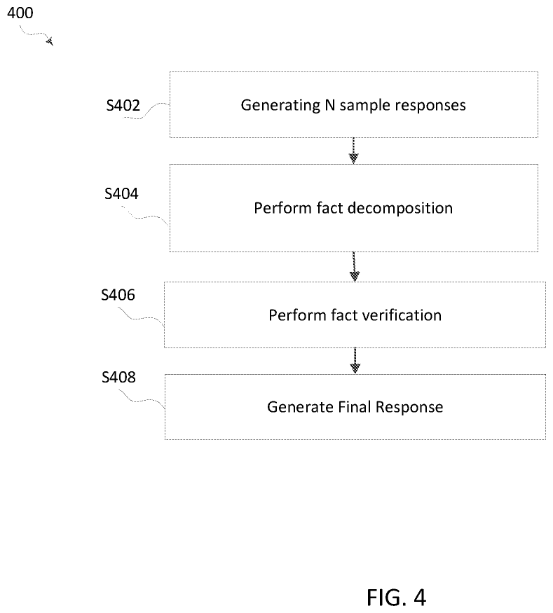

FIG. 4 illustrates a flowchart of a process 400 for performing fine-grained self endorsement. The process 400 may be performed by the processor 220 (FIG. 2).

The process may start at operation S402 where N sample responses are generated. In one or more examples, the N samples responses are generated by inputting the query X into the LLM N times. Each sampling process may be denoted as Yᵢ˜LLM (X).

The process may proceed to operation S404 where fact decomposition is performed. In one or more examples, a fact may be a statement about factual knowledge. Fact decomposition may be performed in accordance with one or more embodiments. In one or more examples, a naive method may be implemented, which takes each sentence in a response as a fact. However, this method does not consider the situations that some sentences may contain multiple independent facts or do not contain any fact. Therefore, in one or more examples, prompting the LLM is prompted to extract facts from the responses. This process

$${f}_{1}^{i} , {f}_{2}^{i} , … , {f}_{{N}_{{Y}_{i}}}^{i} = LLM ( {Y}_{i} , {P}_{D} ) ,$$

may be denoted as where P_{D} is the corresponding LLM instruction shown in Table 1 below:

TABLE 1

List all non-repeated facts from the
text below in numerical order. Each fact should
be a self-contained sentence: Yᵢ

The process may proceed to operation S406 where fact verification is performed. In one or more examples, each fact may be verified via its endorsement score: the degree of the fact being consistent with the content in other sampled responses. There are multiple ways to compare two pieces of text, such as querying the LLM or calling a sentence encoder (e.g. SimCSE). In one or more examples, for reduced computational complexity and to minimize the effect of extra supervision, the LLM may be queried via prompting. For example, for a fact

$${f}_{j}^{i}$$

from response Yᵢ, that fact

$${f}_{j}^{i}$$

and another response Yₖ(k≠i) is inputted into the LLM with prompt P_{V} to determine whether Yₖ endorses

$${f}_{j}^{i} .$$

The output of each iteration of the LLM may be a fact quality score indicating a quality of a fact with respect another sample response. The endorsement score of

$${f}_{j}^{i}$$

may be defined as:

$$g ( {f}_{j}^{i} ) = \frac{1}{N - 1} {\sum }_{k \neq i} LLM ( {f}_{j}^{i} , {Y}_{k} , {P}_{V} ) .$$

The prompt Py may be defined as specified in Table 2 below:

TABLE 2

Take the following as truth: Yₖ
Then the following statement: “fⱼⁱ” is true, false, or inconclusive?

The process proceeds to operation S408 where the final response is generated.

In one or more examples the final response may be generated based on a selection process. For example, one response from the sample responses is selected as the final response Y. For each candidate Yᵢ, the endorsement scores are averaged and sample response with the highest average is selected as the final response. However, these features not fully exploit the potential of our framework due to the following reasons: (1) there can still be factual errors in the selected response; (2) helpful and complementary facts in other responses are not efficiently leveraged.

In one or more examples, the final response may be generated based on a regeneration process. For example, the LLM may be prompted to regenerate the final response Y with selected facts Z) from all samples: Y˜LLM (X, Z, Pc), where prompt PG may be defined as specified in Table 3 below:

TABLE 3

Knowledge from other sources: Z
Given the materials above, answer the question: X

To select useful facts, the facts whose endorsement scores do not exceed a threshold a (i.e., g(fⱼⁱ)≤α) may be discarded. Though this, low-quality facts may be pruned. However, there may still be facts with redundant content. In one or more examples, a K-means algorithm may be adopted that takes bag-of-words features as the representation for each fact and groups the facts into C clusters. Lastly, the fact closest to the centroid for each cluster selected to form the selected fact set Z that contains |C| facts.

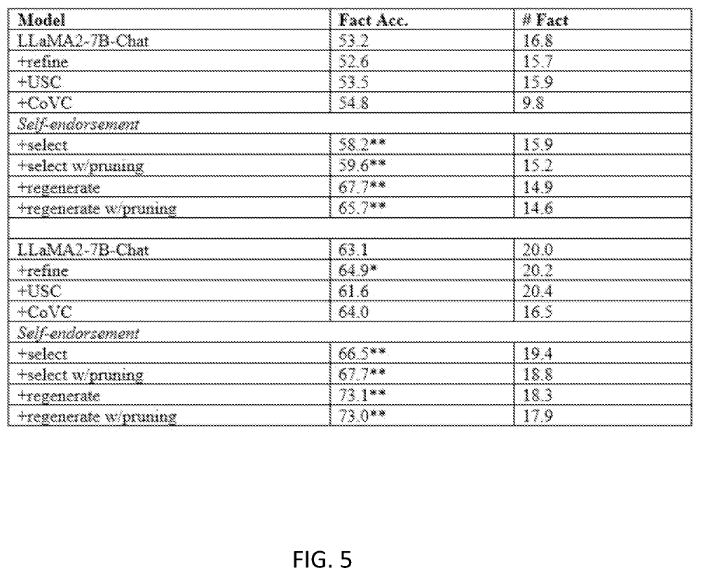

The embodiments of the present disclosure were used to conduct experiments on Biographies. The Biographies contain 183 person entities used to prompt LLMs about their biographies with the query “Tell me a bio of <entity>”. As the responses of LLMs can be long and contain a wealth of factual knowledge, it has been a popular benchmark for evaluating factuality in longform text generation. FIG. 5 reports significant test results using bootstrap resampling. In FIG. 5, * and ** denote significantly better results over the base LLM (the first line in each group) with significance level p<0.05 and p<0.01, respectively. As shown in FIG. 5, none of the baselines (+refine, +USC and +CoVe) significantly improve over the 7B and 70B LLaMA2-Chat model regarding Fact Acc. In contrast, self-endorsement gives significant improvements over baselines no matter whether the final response is selected or regenerated and whether context pruning is used or not. Among those baselines, only CoVe can slightly improve Fact Acc., but decreases the #Fact, which is also observed in previous work. \emph {Refine} only benefits LLaMA2-70B-Chat, while the gain is still much inferior to the self-endorsement approaches based on self-selected high-quality facts. The results of \emph {Refine} also indicate that naive self-refinement demands strong capabilities of the LLM. For the embodiments of the present disclosure, because regeneration can include reliable facts from all candidates and discard incorrect facts, this method consistently produces better responses than selection.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor comprising:
generating, based on inputting an input query into a large language model (LLM), N sample responses, N being an integer greater than zero;
determining, for each sample response, each fact statement included in a respective response;
determining, for each determined fact statement, an endorsement score indicating an accuracy of the fact statement as a response to the input query;
selecting each fact statement having an endorsement score greater than a threshold; and
generating a final response to the input query based on each selected fact statement.

2. The method according to claim 1, wherein the input query is input into the LLM N times to generate the N sample responses, wherein each sample response is different from each other.

3. The method according to claim 1, the determining, for each sample response, each fact statement comprises:
inputting, into the LLM, the respective response and a predetermined instruction for identifying each fact statement in the respective response,
wherein the output of the LLM corresponds to each fact statement in the respective response.

4. The method according to claim 1, wherein the instruction is a text string that instructs the LLM to determine each fact statement in the respective response.

5. The method according to claim 1, wherein the determining, for each determined fact statement, the endorsement score comprises:
inputting, into the LLM for each determined fact statement, a respective fact statement with each other sample response that does not include the respective fact statement and a verification instruction,
wherein the output of the LLM is a fact quality score of the respective fact statement for the respective sample response, and
wherein the endorsement score of the respective fact statement is an average of each fact quality score output of the LLM.

6. The method according to claim 5, wherein the verification instruction to determine the fact quality score instructs the LLM to identify the inputted sample response as a truth and identify the inputted respective fact statement as one of true, false, and inconclusive.

7. The method according to claim 1, wherein the generating the final response comprises selecting the response having the determined fact statements with the highest endorsement score.

8. The method according to claim 1, wherein the generating the final response comprises inputting into the LLM the input query and each fact statement having an endorsement score above a threshold.

9. An apparatus comprising:
at least one memory configured to store program code; and
at least one processor configured to read the program code and operate as instructed by the program code, the program code including:
first generating code configured to cause the at least one processor to generate, based on inputting an input query into a large language model (LLM), N sample responses, N being an integer greater than zero,
first determining code configured to cause the at least one processor to determine, for each sample response, each fact statement included in a respective response,
second determining code configured to cause the at least one processor to determine, for each determined fact statement, an endorsement score indicating an accuracy of the fact statement as a response to the input query,
selecting code configured to cause the at least one processor to select each fact statement having an endorsement score greater than a threshold, and
second generating code configured to cause the at least one processor to generate a final response to the input query based on each selected fact statement.

10. The apparatus according to claim 9, wherein the input query is input into the LLM N times to generate the N sample responses, wherein each sample response is different from each other.

11. The apparatus according to claim 9, the first determining code further causes the at least one processor to:
input, into the LLM, the respective response and a predetermined instruction for identifying each fact statement in the respective response,
wherein the output of the LLM corresponds to each fact statement in the respective response.

12. The apparatus according to claim 9, wherein the instruction is a text string that instructs the LLM to determine each fact statement in the respective response.

13. The apparatus according to claim 9, wherein the second determining code causes the at least one processor to:
input, into the LLM for each determined fact statement, a respective fact statement with each other sample response that does not include the respective fact statement and a verification instruction,
wherein the output of the LLM is a fact quality score of the respective fact statement for the respective sample response, and
wherein the endorsement score of the respective fact statement is an average of each fact quality score output of the LLM.

14. The apparatus according to claim 13, wherein the verification instruction to determine the fact quality score instructs the LLM to identify the inputted sample response as a truth and identify the inputted respective fact statement as one of true, false, and inconclusive.

15. The apparatus according to claim 9, wherein the second generating code further causes the at least one processor to select the response having the determined fact statements with the highest endorsement score.

16. The apparatus according to claim 9, wherein the second generating code further causes the at least one processor to generate the final response by inputting into the LLM the input query and each fact statement having an endorsement score above a threshold.

17. A non-transitory computer readable medium having instructions stored therein, which when executed by a processor cause the processor to execute a method comprising:
generating, based on inputting an input query into a large language model (LLM), N sample responses, N being an integer greater than zero;
determining, for each sample response, each fact statement included in a respective response;
determining, for each determined fact statement, an endorsement score indicating an accuracy of the fact statement as a response to the input query;
selecting each fact statement having an endorsement score greater than a threshold; and
generating a final response to the input query based on each selected fact statement.

18. The non-transitory computer readable medium according to claim 17, wherein the input query is input into the LLM N times to generate the N sample responses, wherein each sample response is different from each other.

19. The non-transitory computer readable medium according to claim 17, wherein the determining, for each sample response, each fact statement comprises:
inputting, into the LLM, the respective response and a predetermined instruction for identifying each fact statement in the respective response,
wherein the output of the LLM corresponds to each fact statement in the respective response.

20. The non-transitory computer readable medium according to claim 17, wherein the instruction is a text string that instructs the LLM to determine each fact statement in the respective response.
